(19) United States
(12) Patent Application Publication
(10) Pub. No.: US 2002/0015272 A1
(43) Pub. Date: Feb. 7, 2002

(54) Switch device and overcurrent controlling method

(75) Inventor: Takahiro Hattori, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/921,789

(22) Filed: Aug. 6, 2001

(30) Foreign Application Priority Data
Aug. 4, 2000 (JP) 2000-236659

(51) Int. Cl. H02H 3/08

(52) U.S. Cl. 361/93.1

(57) ABSTRACT

A switch device is provided with a MOSFET (field effect transistor) connected between an input and an output, an overcurrent detecting circuit for detecting the overcurrent when the current flowing in the MOSFET exceeds a predetermined value, and a gate controlling circuit for controlling an ON/OFF state of the MOSFET by controlling the gate voltage of the MOSFET. The gate controlling circuit changes the gate voltage such that ON resistance of the MOSFET is gradually decreased after it rises once when the MOSFET is changed from the OFF state to the ON state.

### BACKGROUND OF THE INVENTION

1. Field of the Invention

The present invention relates to a switch device having overcurrent detecting function and an overcurrent controlling method, in particular, a switch device and an overcurrent controlling method suitable for a device which copes with an inrush current.

2. Description of the Related Art

FIG. 1 is a circuit diagram showing the composition of a conventional switch device having an overcurrent detecting function. A switch 1 is connected between an input 5 and an output 6. The switch 1 is composed of a P-channel MOSFET having a low ON resistance. The source of the P-channel MOSFET is connected to the input 5, and the drain thereof is connected to the output 6. A gate controlling circuit 2A for supplying a gate voltage to the P-channel MOSFET is provided. By the gate controlling circuit 2A, an ON/OFF state of the switch 1 is controlled. An overcurrent detecting circuit 3A for notifying an active overcurrent detecting signal 10 to the gate controlling circuit 2A as an overcurrent detecting result when the current of the output 6, that is, the current flowing in the switch 1 exceeds a predetermined current value (detected overcurrent value) is provided. For example, these circuits are integrated as an integrated circuit (IC).

The gate controlling circuit 2A sets the gate voltage of the switch 1 to 0V when the switch 1 is in an ON state, and sets the gate voltage of the switch 1 to the voltage level of the input 5 when the switch 1 is in an OFF state. When the switch 1 is turned ON, the voltage having nearly the same level as that of the input 5 is outputted at the output 6, because the ON resistance of the switch 1 is small.

When the overcurrent detecting circuit 3A detects the overcurrent, it changes a flag 8 from a high level to a low level to notify the purport that the overcurrent is detected to the outside. When a controller 13 receives the notification that the flag 8 is changed to the low level, it outputs a control signal 7 for indicating the OFF state of the switch 1. When the gate controlling circuit 2A receives the control signal 7 (indication of the OFF state of the switch 1), then sets the gate voltage of the switch 1 to the same level as that of the input 5. As the result, the switch 1 is turned OFF.

In other words, when the output current exceeds the detected overcurrent value, the flag 8 is set to the ON state by the overcurrent detecting circuit 3A. And, the gate controlling circuit 2A sets the switch 1 to the OFF state.

Also, in order to return the switch 1 to the ON state, the control signal 7 from the controller 13 (control signal for indicating the ON state of the switch 1) needs to be inputted to the gate controlling circuit 2A. Accordingly, as long as there is no indication, the switch 1 is in the OFF state as it is, and the voltage does not appear at the output 5.

On the other hand, in case of a USB (Universal Serial Bus) device, occasionally an inrush current flows exceeding the detected overcurrent value. Therefore, in the above-mentioned composition, when the USB device is connected, since the overcurrent is detected by the inrush current and the switch 1 is turned OFF, the USB device cannot be used. Hereinafter, this problem will be explained in detail.

When the USB device is connected, the inrush current always flows. Therefore, in order to suppress the inrush current, generally, an inductance or the like are connected between the switch 1 and the output 5 to allow the current waveform to be dull. However, in a practical manner, there is an USB device which cannot cope with this problem completely by providing only the inductance or the like.

In addition, in the conventional composition, when the USB device in which the current exceeding the detected overcurrent value of high side switch flows is connected, the high side switch cannot determine whether the overcurrent is generated by the inrush current or by abnormal connection. Therefore, the switch is turned OFF by the inrush current, thereby the USB device cannot be used.

Also, in the above-mentioned conventional composition, during the detection of the overcurrent, a limitation for the current can not be performed. Therefore, in the case that a large load is connected to the output, the power consumption on the inside of the IC becomes large and in the worst case, there is a problem that the chip is destroyed and then the output becomes a short-circuit or open-circuit. So, the present inventor suggests an overcurrent limiting method which the switch is composed of two MOSFETs having different ON resistance, in the high side switch having the overcurrent limiting function (Japanese Laid-Open Patent No. 2000-13991). In the overcurrent limiting method, a first switch is composed of a MOSFET having a low ON resistance, and a second switch is composed of a MOSFET having a high ON resistance. In general operation, the first switch is turned ON. When the overcurrent detecting means detects the overcurrent value flowing in the first switch, the signal is sent to the current limit controlling means. Then, the gate voltage of the first switch is gradually changed, and the ON resistance thereof becomes high. And, the gate voltage is changed until the current flowing in the first switch becomes a set value. When the current becomes the set value, the second switch is turned ON.

In this composition, when the overcurrent is detected, the ON resistance of the MOSFET (first switch) gradually becomes high, and the current is limited in relation to a predetermined set resistance value (second switch).

### SUMMARY OF THE INVENTION

A first object of the present invention is to provide a switch device and an overcurrent controlling method which can cope with a device in which the inrush current flows exceeding the detected overcurrent value when the device is connected. A second object of the present invention is to provide a switch device and an overcurrent controlling method which the ON/OFF state of the switch can be controlled by determining whether the overcurrent is generated by the inrush current or by the abnormal connection.

According to one aspect of the present invention, a switch device comprises a field effect transistor connected between an input and an output, an overcurrent detecting circuit which detects an overcurrent when a current flowing in said field effect transistor exceeds a predetermined value, and a gate controlling circuit which controls an ON/OFF state of said field effect transistor by controlling a gate voltage of said field effect transistor. The gate controlling circuit changes said gate voltage such that ON resistance of said field effect transistor is gradually decreased after it rises once when said field effect transistor is changed from the OFF state to the ON state.

According to another aspect of the present invention, a switch device comprises a field effect transistor connected between an input and an output, a digital/analog converter whose output terminal is connected to a gate terminal of said field effect transistor, an overcurrent detecting circuit which detects an overcurrent when a current flowing in said field effect transistor exceeds a predetermined value, and a gate controlling circuit which controls an ON/OFF state of said field effect transistor by controlling a gate voltage of said field effect transistor through said digital/analog converter. The gate controlling circuit outputs a digital signal to said digital/analog converter and changes said gate voltage such that ON resistance of said field effect transistor is gradually decreased after it rises once when said field effect transistor is changed from the OFF state to the ON state.

According to the present invention, it is possible to cope with the inrush current. In addition, the operation can be distinguished by determining the inrush current or the abnormal current such as the output short-circuit. Accordingly, the present invention is suitable for the connection of the USB device.

### BRIEF DESCRIPTION OF THE DRAWINGS

The above and other objects, features and advantages of the present invention will be better understood from the following description taken in conjunction with the accompanying drawings, in which:

FIG. 1 is a circuit diagram showing the composition of a conventional switch device having an overcurrent detecting function;

FIG. 2 is a circuit diagram showing the composition of a switch device according to a first embodiment of the present invention;

FIG. 3 is a flowchart illustrating the operation in the first embodiment of the present invention;

FIG. 4 is a timing chart illustrating an example of the operating waveform when an inrush current flows in the first embodiment;

FIG. 5 is a timing chart illustrating an example of the operating waveform when an abnormal current flows in the first embodiment;

FIG. 6 is a circuit diagram showing the composition of a switch device according to a second embodiment of the present invention;

FIG. 7 is a timing chart illustrating an example of the operating waveform when an inrush current flows in the second embodiment.

### DETAILED DESCRIPTION OF THE PREFERRED EMBODIMENTS

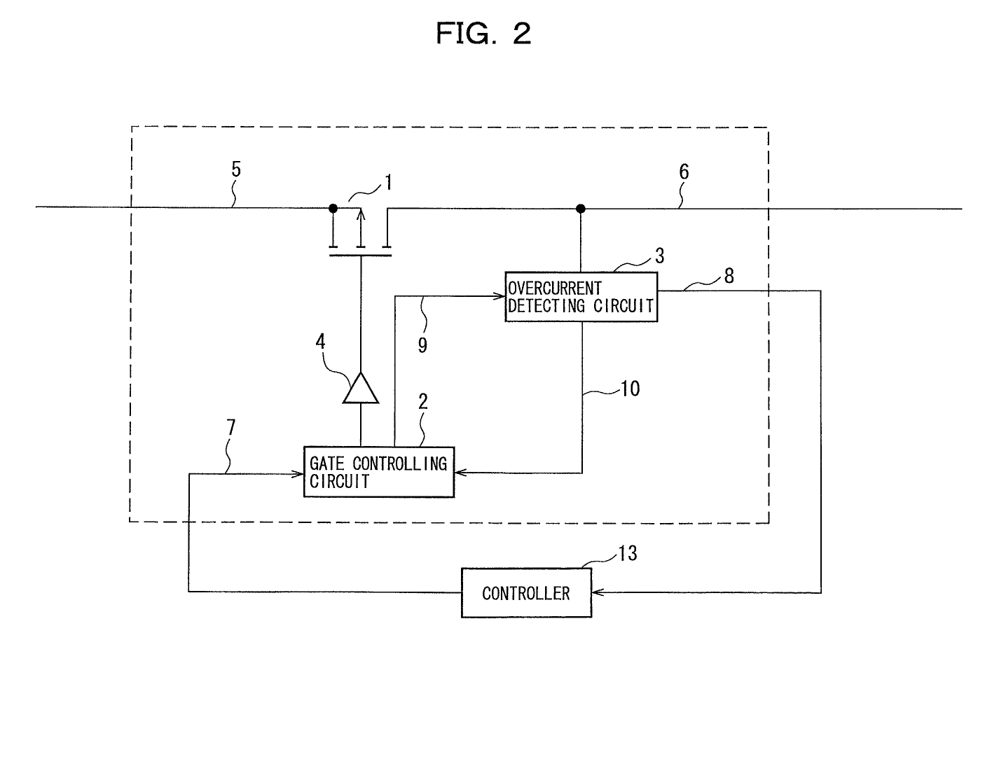

Hereinafter, the preferred embodiments of the present invention will be explained with reference to the accompanying drawings. FIG. 2 is a circuit diagram showing the composition of a switch device according to a first embodiment of the present invention.

In the first embodiment, a switch 1 connected between an input 5 and an output 6, an overcurrent detecting circuit 3 for detecting overcurrent when the current flowing in the switch 1 exceeds a predetermined normal current value (threshold value), and a gate controlling circuit 2 for controlling a gate voltage supplied to a gate terminal of a MOSFET composing the switch 1 to control the ON/OFF state of the switch 1 are provided. For example, the switch 1 is composed of a P-channel MOSFET, the source of which is connected to the input 5 and the drain of which is connected to the output 6. A control signal 7 outputted from the outside (a controller 13) for indicating the ON/OFF state of the switch 1 and an overcurrent detecting signal 10 outputted from the overcurrent detecting circuit 3 are inputted to the gate controlling circuit 2. Also, in the first embodiment, a digital/analog (D/A) converter 4 is provided. The output of the D/A converter 4 is connected to the gate terminal of the MOSFET, and the input thereof is connected to the gate controlling circuit 2. A digital signal is outputted from the gate controlling circuit 2 to the D/A converter 4.

The D/A converter 4 may be built in the gate controlling circuit 2. Also, the composition that the output of the D/A converter 4 is supplied to the gate terminal of the MOSFET through a buffer circuit (voltage follower or the like) may be taken.

The gate controlling circuit 2 gradually changes the voltage supplied to the gate terminal through the D/A converter 4 when the state of the switch 1 is changed from the OFF state to the ON state, thereby the ON resistance of the switch 1 is gradually decreased after it becomes high resistance once. In other words, a slow start operation is performed by the gate controlling circuit 2.

The gate controlling circuit 2 outputs a slow start signal 9 to the overcurrent detecting circuit 3 as an active state when the slow start operation is performed.

The overcurrent detecting circuit 3 is connected to the drain of the P-channel MOSFET of the switch 1. The overcurrent detecting circuit 3 compares the value of the current flowing in the output 6 with a predetermined normal value, and detects the overcurrent state when the output current having the current value exceeding the predetermined normal value flows. When the overcurrent detecting circuit 3 detects the overcurrent state, it outputs a flag 8 and an overcurrent detecting signal 10 according to a logic value of the slow start signal 9. Concretely, if the overcurrent state is detected when the slow start signal 9 is in the active state, the flag 8 for notifying the purport that the overcurrent is detected to the outside is turned ON. The notification is notified to the controller 13. On the other hand, if the overcurrent detecting circuit 3 detects the overcurrent state when the slow start signal 9 is in an inactive state, the flag 8 is not turned ON, and the overcurrent detecting signal 10 becomes an active state. In result, the purport that the overcurrent is detected is notified to the gate controlling circuit 2. In this case, the notification to the controller 13 is not performed.

When the gate controlling circuit 2 receives the overcurrent detecting signal 10 in the active state, it performs the slow start operation in the state that the switch 1 is in the OFF state. Also, since the control signal 7 inputted to the gate controlling circuit 2 is a signal from the outside, it may be high active or low active. Hereinafter, it is assumed that the gate controlling circuit 2 is high active. In other words, when the control signal 7 is low level, the gate controlling circuit 2 becomes the OFF state, and when the control signal 7 is high level, the gate controlling circuit 2 becomes the ON state.

The gate controlling circuit 2 supplies the digital signal to the digital/analog converter 4. The digital/analog converter 4 outputs the analog voltage. The analog voltage is supplied to the gate terminal of the MOSFET.

When the switch 1 is changed from the OFF state to the ON state, the gate controlling circuit 2 controls the operation of the D/A converter 4 as follows.

When the switch 1 is changed from the OFF state to the ON state, the output of the D/A converter 4 is the gate voltage of the switch 1. When the switch 1 holds the OFF state, the gate controlling circuit 2 outputs the voltage having the same level as that of the input 5 to the D/A converter 4. When the switch 1 holds the ON state, the gate controlling circuit 2 outputs a ground level (0V) to the D/A converter 4.

When the switch 1 is changed from the OFF state to the ON state, the gate controlling circuit 2 controls the digital signal supplied to the input terminal of the D/A converter 4 such that the output of the D/A converter 4 is gradually changed from the voltage level of the input 5 to the ground level. This operation is referred as “slow start operation”.

In case that the input of the D/A converter 4 is 4 bits and the voltage having the range from 0V (input code=0) to the voltage of the input 5 (input code=15) is outputted, by the gate controlling circuit 2, the value of the input digital signal of the D/A converter 4 is successively changed to, for example, 15(“1111”), 14(“1110”), 13(“1101”), . . . , 2(“0010”), 1(“0001”), 0(“0000”) for each predetermined timing. When the gate voltage is gradually changed from the voltage level of the input 5 (the switch 1 is in the OFF state) to the ground level, the ON resistance of the MOSFET gradually becomes decreased. Incidentally, the ON resistance rON of the P-channel MOSFET of the switch 1 becomes small in inverse proportion to the magnitude of |VG-VTH| at a point in time that the gate voltage (VG) is lower than the threshold voltage VTH from the voltage of the input 5.

On the other hand, in case that the switch 1 is changed from the ON state to the OFF state, the gate controlling circuit 2 instantaneously changes the output of the D/A converter 4 from the ground potential (0V) to the voltage level of the input 5. In other words, in case of a D/A converter of 4 bits, the input of the D/A converter 4 which was 0 (“0000”) is instantly set to 15(“1111”).

The gate controlling circuit 2 outputs the slow start signal 9 to the overcurrent detecting circuit 3 for a period that the ON resistance of the switch 1 (ON resistance of the MOSFET) is controlled.

For a period that the slow start signal 9 is outputted (slow start period), when overcurrent state is detected by the overcurrent detecting circuit 3, the flag 8 becomes the ON state by the overcurrent detecting circuit 3.

On the other hand, except for the slow start period, when the overcurrent state is detected by the overcurrent detecting circuit 3, the overcurrent detecting signal 10 is outputted from the overcurrent detecting circuit 3. And, the gate controlling circuit 2 starts the slow start operation.

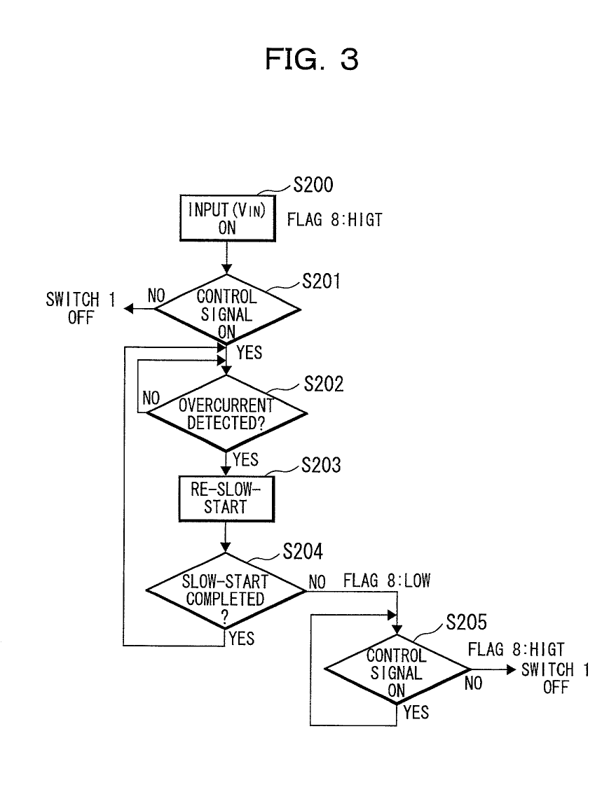

FIG. 3 is a flowchart illustrating the operation in the first embodiment of the present invention.

In case that the voltage (VIN) of the input 5 is ON, and the control signal 7 becomes in the ON state (steps S200 and S201), the overcurrent detecting circuit 3 starts the detection of the overcurrent while the gate controlling circuit 2 changes the switch 1 to the ON state (step S202).

During the detection of the overcurrent (step S202), when the switch 1 is changed from the OFF state to the ON state, the gate controlling circuit 2 gradually decreases the voltage supplied from the D/A converter 4 to the gate terminal of the MOSFET of the switch 1 from the voltage of the input 5 to allow the ON resistance of the MOSFET of the switch 1 to gradually become smaller. In other words, the slow start (re-slow-start) operation is performed. At this time, the gate controlling circuit 2 outputs an active slow start signal (step S203).

Before the slow start operation is completed, during the slow start operation period, if the overcurrent detecting circuit 3 detects the overcurrent state (step S204), the overcurrent detecting circuit 3 sets the flag 8 to the ON state (low level), and notifies the purport that the overcurrent is detected to the outside, for example, the controller 13.

The controller 13 sets the control signal 7 to the OFF state (low level). The gate controlling circuit 2 receives the control signal 7 and switches the output of the D/A converter 4 to the voltage level of the input 5. And, the switch 1 is turned OFF (step S205).

In other words, the following operation is performed.

When the switch 1 is changed from the OFF state to the ON state, the gate controlling circuit 2 performs the slow start operation that the gradually change of the voltage supplied from the digital/analog converter 4 to the gate terminal of the MOSFET of the switch allows to gradually decrease the ON resistance of the switch. At this time, the gate controlling circuit 2 outputs the slow start signal 9 as an active state.

When the slow start signal 9 outputted from the gate controlling circuit 2 is in the active state, if the overcurrent state is detected, the overcurrent detecting circuit 3 sets the flag 8 for notifying the purport that the overcurrent is detected to the outside to the ON state.

When the slow start signal 9 outputted from the gate controlling circuit 2 is in the inactive state, if the overcurrent state is detected, the overcurrent detecting circuit 3 outputs the overcurrent detecting signal 10 as the active state to notify the purport that the overcurrent is detected to the gate controlling circuit 2. At this time, the overcurrent detecting circuit 3 does not set the flag 8 to the ON state.

If the gate controlling circuit 2 receives the overcurrent detecting signal 10 in the active state from the overcurrent detecting circuit 3, it performs the slow start operation again at the state after it makes the switch of in the OFF state.

In case that the flag 8 is in the ON state, on the basis of the flag which becomes the ON state, the controller 13 supplies the control signal 7 for indicating the OFF state of the switch 1 to the gate controlling circuit 2.

In the USB device, there necessarily exists an input capacity. Accordingly, when the USB device is connected, in order to charge the input capacity of the power supply side, the inrush current flows rapidly. In consideration of the USB system, the most important problem in the power supply management is to cope with the inrush current flowing when the USB device is connected.

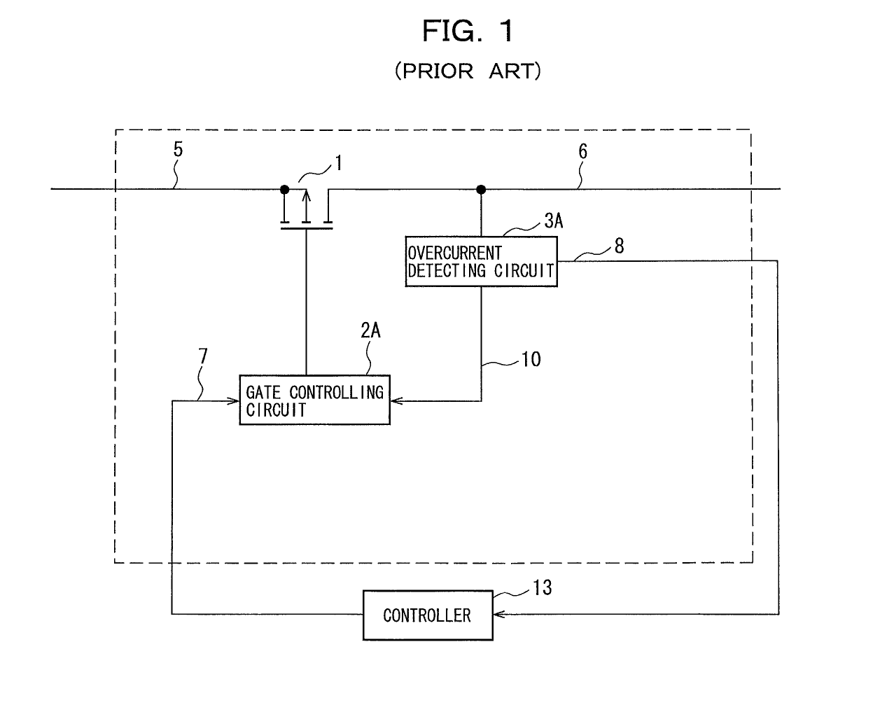

In the USB standard, the upper limit current supplying value of the power supply line is prescribed to 500 mA. In case that the current exceeding 500 mA flows, the switch 1 needs to become the OFF state. But, the switch 1 must not perform the detection of the overcurrent with respect to the inrush current flowing instantaneously into the lower USB device. Generally, the period is about 10 μ seconds. However, in actual use, there are USB devices in which the inrush current flows exceeding 10 μ seconds. Therefore, in case of the conventional composition shown in FIG. 1, the detection of the overcurrent is performed in response to the inrush current exceeding 10 μ seconds, thereby the switch 1 becomes the OFF state.

However, when the USB device is connected to the USB port, the current which the amount thereof largely exceeds the USB standard value (about 3A) instantaneously (during about 10 μseconds) flows in a great number of equipment.

Therefore, in the power supply management of the USB system, in case of the inrush current, the operation is continuously performed (that is, the current limit is performed, but the switch 1 is not in OFF state), and in case that the abnormal current such as the short-circuit mode is generated, the composition that the switch 1 is cut off must be taken.

According to the first embodiment, with respect to the inrush current, the gate controlling circuit 2, which receives the overcurrent detecting signal 10 performs the slow start operation, thereby performing the current limit. Also, in the case that abnormal current is generated, and flag 8 is outputted as the ON state, thereby the switch 1 is turned OFF.

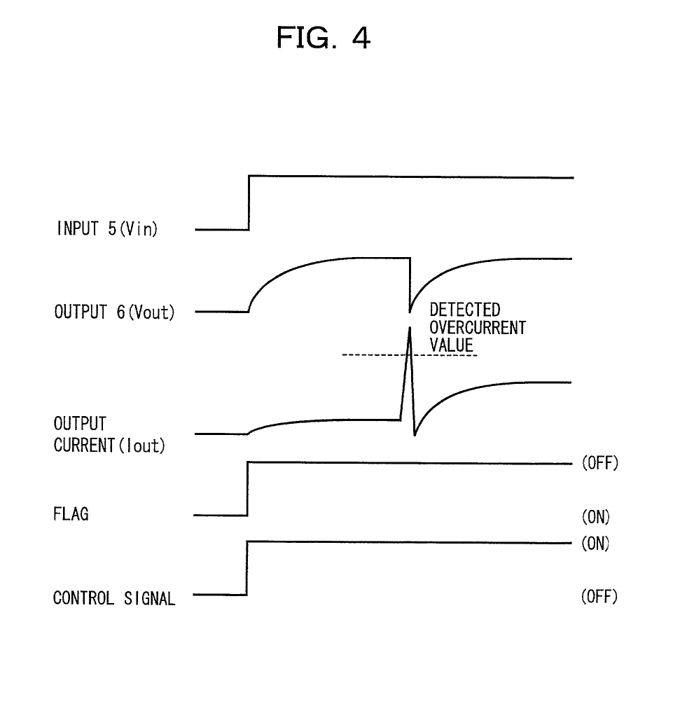

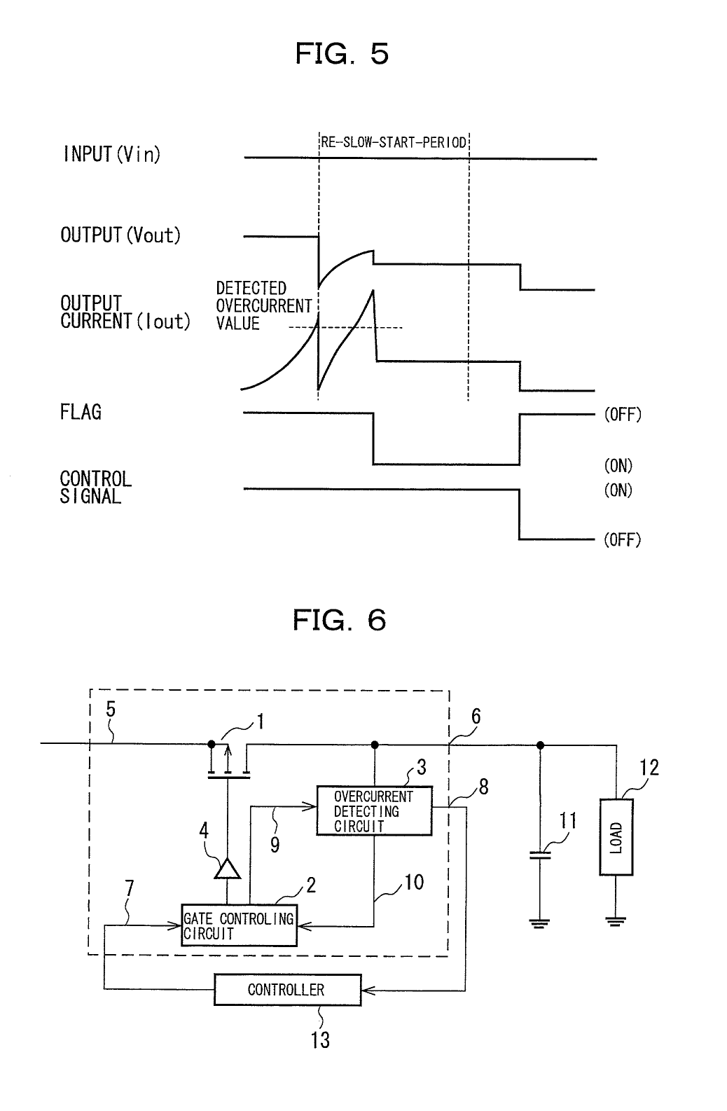

FIG. 4 is a timing chart illustrating an example of the operation waveform when an inrush current flows in the first embodiment. FIG. 5 is a timing chart illustrating an example of the operation waveform when an abnormal current flows in the first embodiment. In FIGS. 4 and 5, “input 5”, “output 6”, “flag”, and “control signal” represent voltage waveforms, and “output current (Iout)” represents current waveform of the output 6.

As shown in FIG. 4, according to the first embodiment, though the inrush current flows and the output current Iout flows exceed the detected overcurrent value when the USB device is connected, the current can be limited by performing the slow start operation. In this case, the flag 8 becomes the OFF state (high level) as it is, and the detection of the overcurrent is not notified to the controller 13. Accordingly, the control signal 7 is in the ON state (high level) as it is.

Also, as shown in FIG. 5, in case that large current due to an abnormal connection flows, the overcurrent detecting circuit 3 detects the overcurrent during the slow start (re-slow-start) operation. At this result, the flag 8 becomes the ON state to notify the purport that the overcurrent is detected to the outside (controller 13). Then, the controller 13 outputs the control signal 7 to the gate controlling circuit 2 as the OFF state (low level).

Thus, according to the first embodiment, by connecting an inductance commonly used for the power supply circuit of the USB device, the power supply management of the USB device can be performed without requiring the outside attachment circuit which allows the waveform to be dull.

When a USB device is connected, the inrush current flows only for a short period (about 10 μ seconds). At this time, the switch 1 becomes the OFF state once as when the power supply is in the ON state, and is changed from the OFF state to the ON state by performing the slow start operation again. At the period during which the switch 1 is changed from the OFF state to the ON state, since the ON resistance of the switch 1 is large, the large current of the inrush current does not flow. And, after the slow start operation is finished, the operation of the switch can be normally performed.

Next, a second embodiment of the present invention will be explained. FIG. 6 is a circuit diagram showing the composition of the switch device according to the second embodiment of the present invention.

In the second embodiment, in addition to the compositions of the first embodiment, a smoothing condenser 11 is connected to the load in parallel at the output 6. The capacity of the condenser 11 is relatively large.

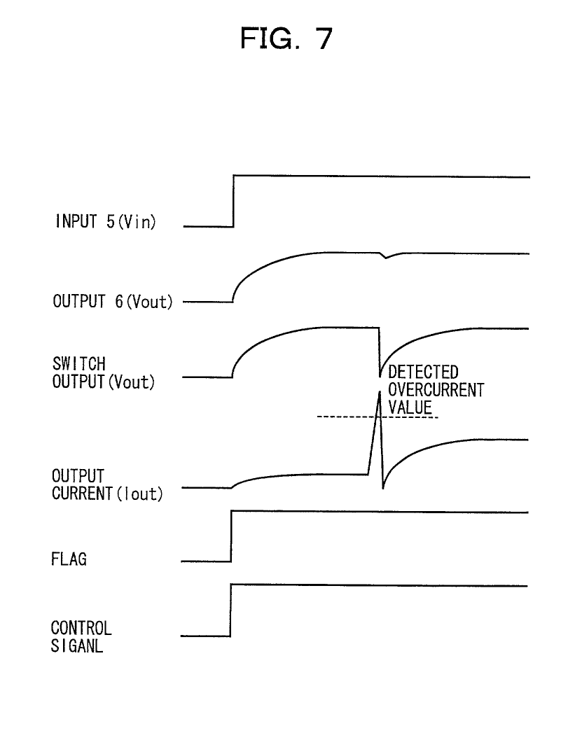

FIG. 7 is a timing chart illustrating an example of the operation waveform when an inrush current flows in the second embodiment.

In the present embodiment, though the switch 1 becomes the OFF state once by the inrush current and the slow start operation is started, as shown in FIG. 7, the voltage of the output 6 becomes smooth, because the condenser 11 is connected to a load 12 in parallel. Therefore, the voltage value supplied to the USB device connected to the output 6 does not change largely.

Supposed that the output 6 is connected to the ground, the re-slow-start operation is performed, but, since the current continuously flows during the slow start period, the overcurrent is detected if the ON resistance of the switch 1 reaches a low ON resistance value.

If the overcurrent is detected when the slow start signal 9 is in the active period (during the slow start period), the flag 8 becomes the ON state. If the overcurrent is detected when the slow start signal 9 is in the inactive period, the active overcurrent detecting signal 10 is outputted to the gate controlling circuit 2. And, the gate controlling circuit 2 controls the switch 1 to perform the re-slow-start operation. Therefore, the time that the inrush current is generated and the time that the abnormal operation such as the output short-circuit is generated are clearly distinguished. In other words, the control operation of the switch 1 can be distinguished.

Although the technical spirit of the present invention has been disclosed with reference to the appended drawings and the preferred embodiments of the present invention corresponding to the drawings, the descriptions in the present specification are only for illustrative purpose, not for limiting the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A switch device comprising:
a field effect transistor connected between an input and an output;
an overcurrent detecting circuit which detects an overcurrent when a current flowing in said field effect transistor exceeds a predetermined value; and
a gate controlling circuit which controls an ON/OFF state of said field effect transistor by controlling a gate voltage of said field effect transistor, said gate controlling circuit changing said gate voltage such that ON resistance of said field effect transistor is gradually decreased after it rises once when said field effect transistor is changed from the OFF state to the ON state.

2. The switch device according to claim 1, wherein said gate controlling circuit is supplied with a control signal from the outside indicating the OFF state of said field effect transistor and an overcurrent detecting signal outputted from said overcurrent detecting circuit.

3. The switch device according to claim 1, wherein said gate controlling circuit does not hold said switch in the OFF state even though said overcurrent detecting circuit detects the overcurrent due to an inrush current.

4. The switch device according to claim 1, wherein said gate controlling circuit sets said field effect transistor to the OFF state in case that said overcurrent detecting circuit detects the overcurrent while the ON resistance of said field effect transistor is gradually decreased.

5. A switch device comprising:
a field effect transistor connected between an input and an output;
a digital/analog converter whose output terminal is connected to a gate terminal of said field effect transistor;
an overcurrent detecting circuit which detects an overcurrent when a current flowing in said field effect transistor exceeds a predetermined value; and
a gate controlling circuit which controls an ON/OFF state of said field effect transistor by controlling a gate voltage of said field effect transistor through said digital/analog converter, said gate controlling circuit outputting a digital signal to said digital/analog converter and changing said gate voltage such that ON resistance of said field effect transistor is gradually decreased after it rises once when said field effect transistor is changed from the OFF state to the ON state.

6. The switch device according to claim 1, wherein
said gate controlling circuit outputs an active slow start signal to said overcurrent detecting circuit while said gate voltage is gradually changed while said field effect transistor is changed from the OFF state to the ON state,
said overcurrent detecting circuit notifies a purport that the overcurrent is detected to the outside if the overcurrent is detected when said slow start signal is in the active state, and notifies a purport that the overcurrent is detected to said gate controlling circuit by setting said overcurrent detecting signal to the active state if the overcurrent is detected when said slow start signal is in the inactive state, said gate controlling circuit sets said field effect transistor to the OFF state and changes said gate voltage again if the purport that the overcurrent is detected is notified by said overcurrent detecting circuit.

7. The switch device according to claim 6, further comprising a controller which outputs a control signal to set said field effect transistor to the OFF state to said gate controlling circuit if it is receives notification of the purport that the overcurrent is detected by said overcurrent detecting circuit.

8. The switch device according to claim 1, further comprising a load connected to said output and a smoothing condenser connected to said load in parallel.

9. The switch device according to claim 1, wherein said field effect transistor is a P-channel field effect transistor.

10. The switch device according to claim 9, wherein said gate controlling circuit gradually changes the output voltage of said digital/analog converter from a voltage level of said input to 0V when said gate voltage is gradually changed, such that the ON resistance of said switch is gradually decreased after it rises once.

11. The switch device according to claim 1, wherein said switch device is used as a high side switch.

12. A overcurrent limiting method of a switch device having a field effect transistor connected between an input and an output, a digital/analog converter whose output terminal is connected to a gate terminal of said field effect transistor, an overcurrent detecting circuit which detects an overcurrent when a current flowing in said field effect transistor exceeds a predetermined value, and a gate controlling circuit which controls an ON/OFF state of said field effect transistor by controlling a gate voltage of said field effect transistor through said digital/analog converter, the method comprising the steps of:
outputting a digital signal to said digital/analog converter and outputting an active slow start signal toward said overcurrent detecting circuit such that ON resistance of said field effect transistor is gradually decreased after it rises once, when said field effect transistor is changed from the OFF state to the ON state in the gate controlling circuit;
notifying a purport that the overcurrent is detected to the outside by said overcurrent detecting circuit if said overcurrent detecting circuit detects the overcurrent when said slow start signal is in an active state;
notifying a purport that the overcurrent is detected to said gate controlling circuit with outputting said overcurrent detecting signal in an active state by said overcurrent detecting circuit if said overcurrent detecting circuit detects the overcurrent when said slow start signal is in an inactive state;
outputting by said gate controlling circuit a digital signal to said digital/analog converter such that said field effect transistor is set to the OFF state and then the ON resistance of said field effect transistor is gradually decreased again, when said gate controlling circuit receives said overcurrent detecting signal in the active state; and
outputting a control signal for setting said field effect transistor to the OFF state to said gate controlling circuit by a controller provided on the outside when the notification of a purport that the overcurrent is detected is received.
